(19) United States
(12) Patent Application Publication
(10) Pub. No.: US 2026/0300416 A1
(43) Pub. Date: Oct. 1, 2026

(54) System and Method for Context-Aware Adaptive Virtual Reality Assistance with Dynamic Emotional Intelligence and Secure Environment Transitions

(71) Applicant: SEBASTIAAN CONRAD ASTON-MARTIN VAN NUISSENBURG, BRISBANE (AU)

(72) Inventor: SEBASTIAAN CONRAD ASTON-MARTIN VAN NUISSENBURG, BRISBANE (AU)

(21) Appl. No.: 19/096,778

(22) Filed: Apr. 1, 2025

(51) Int. Cl. G06F 16/9535; G06F 16/9537; G06T 13/40

(52) U.S. Cl. CPC G06F 16/9535; G06F 16/9537; G06T 13/40

(57) ABSTRACT

A system for providing adaptive assistance across diverse environments integrates context awareness, emotional intelligence, persona adaptation, and secure communication technologies within a unified framework. The system includes a context awareness engine configured to detect a user's location and analyze environmental data; a processor configured to generate a virtual companion based on multimodal input data; a persona adaptation module configured to transition the virtual companion between context-specific personas; an emotional intelligence module configured to determine user emotional states; and a cognitive adaptive learning module configured to generate intervention strategies responsive to those states. A communication interface establishes secure connections with client systems using quantum encryption protocols. A memory stores multimodal data, user preferences, behavioral models, and environmental configurations. A rendering module presents the virtual companion via one or more output devices. A backend platform synchronizes user data across multiple environments. The system provides personalized, context-sensitive assistance that dynamically adapts to the user's needs and surrounding conditions.

### CROSS-REFERENCE TO RELATED APPLICATIONS

This application claims priority to and the benefit of U.S. Non-Provisional application Ser. No. 19/046,559, filed on Feb. 6, 2025, the entire contents of which are incorporated herein by reference.

### FIELD OF INVENTION

The present invention relates generally to adaptive real-time assistance systems and, more particularly, to systems and methods incorporating geolocation-based context awareness, emotional intelligence to deliver personalized, real-time support across both public and private environments.

### BACKGROUND

Advances in artificial intelligence, virtual reality, and machine learning have enabled the development of assistive technologies aimed at improving independence and quality of life for individuals with cognitive, developmental, and physical disabilities. These technologies have proven effective in delivering task-specific support in certain controlled settings. However, despite such progress, conventional assistive systems remain limited in their ability to provide truly adaptive, context-sensitive assistance in complex, real-world environments.

Existing systems frequently operate within narrowly defined contexts and rely on static programming or limited adaptive capabilities. While such configurations may suffice for structured tasks in predictable environments, they often fail to provide effective support in dynamic settings such as retail stores, public transportation hubs, restaurants, or other community locations. The inability to adapt in real time to environmental variability undermines the utility of these systems when users encounter novel challenges or unexpected disruptions.

One significant limitation is the lack of geolocation awareness and context-specific functionality. Many existing solutions cannot detect when a user has entered a new physical space, nor can they establish secure connections with location-specific networks or retrieve relevant contextual information (e.g., store layouts or real-time inventory). As a result, users are frequently required to operate separate applications for different environments, leading to fragmented workflows and increased cognitive burden.

Furthermore, current systems typically do not support transitions between public and private domains. For example, a user receiving guidance in a retail environment must often switch platforms or applications to receive related assistance—such as cooking instructions—after returning home. This discontinuity disrupts task flow and can deter continued engagement, particularly among individuals requiring consistent support across settings.

A further drawback of conventional systems is their limited capacity to interpret and respond to nuanced emotional states. While some systems incorporate basic sentiment analysis or scripted responses, they generally lack the capability to assess multimodal emotional cues such as facial expressions, tone of voice, and physiological signals. This shortfall restricts the system's ability to offer appropriate emotional interventions or adaptive feedback during high-stress or emotionally demanding situations—functionality that is especially critical for users with emotional regulation difficulties or sensory processing sensitivities.

Additionally, existing technologies often utilize static personas that do not adapt to user context or task requirements. These systems typically maintain a consistent interaction model, irrespective of the environment or objective, resulting in generic and sometimes irrelevant assistance. The inability to transition between specialized personas—such as from a general assistant to a task-specific virtual chef—limits both the depth and specificity of support that can be provided.

Security and privacy concerns also remain inadequately addressed. Many assistive systems rely on traditional encryption protocols to transmit sensitive user data, including preferences, interaction history, and task records. These protocols may be vulnerable to future quantum computing capabilities, posing risks to data integrity and user privacy—particularly in public environments where multiple systems may interact with the user's device.

Integration with mobile and augmented reality platforms presents additional challenges. While some existing tools offer limited mobile support or rudimentary AR overlays, few are capable of delivering immersive, spatially-aware guidance that adapts in real time to the user's surroundings. The lack of robust, intuitive interfaces further hampers usability and restricts accessibility across a range of user needs.

Finally, most current solutions function as discrete, task-specific tools rather than as components of a unified ecosystem. They fail to integrate emotional intelligence, contextual adaptation, task guidance, and secure data management within a cohesive framework. As a result, users must navigate multiple disconnected systems, each addressing only a fragment of their overall needs. This fragmented approach impedes personalization, limits scalability, and undermines the potential for cross-contextual learning and long-term adaptability.

Accordingly, there exists a need for an integrated, secure, and adaptive assistive system capable of delivering personalized guidance across varied environments, with real-time context awareness, emotional intelligence, persona adaptation, and secure data handling. Addressing these deficiencies is essential to enabling broader, more independent participation by individuals with disabilities and enhancing task execution for all users in dynamic, real-world settings.

It is within this context that the present invention is provided.

### SUMMARY

The present invention provides a system and method for adaptive assistance that integrates context awareness, emotional intelligence, dynamic persona adaptation, and quantum-secure communication within a unified, modular architecture. The system is configured to deliver personalized, real-time support across a range of environments, including both public spaces and private settings.

The system includes a context awareness engine configured to detect a user's location, analyze environmental parameters, and retrieve environment-specific data from client systems. A processor is operatively coupled to the context awareness engine and is configured to process multimodal input data and generate a virtual companion, which dynamically adapts based on user location and contextual changes. The system further comprises a persona adaptation module that enables transitions between distinct persona representations, an emotional intelligence module that analyzes user emotional states based on multimodal signals, and a cognitive adaptive learning module that selects and delivers personalized intervention strategies.

In certain embodiments, secure data communication between the user system, client systems, and backend infrastructure is maintained using quantum key distribution (QKD) protocols. A memory stores multimodal input data, user preferences, behavioral models, and environmental configuration data, while a backend platform manages synchronization and continuous model refinement. Output is delivered through various devices including mobile displays, AR/VR headsets, smart speakers, and haptic-enabled wearables, allowing for flexible, device-appropriate rendering of the virtual companion.

In some embodiments, the system receives and processes multimodal input data including geolocation signals, visual and audio input, motion sensor data, and biometric information. This data is used to detect user context and affective state with enhanced precision.

In further embodiments, the context awareness engine employs location detection technologies such as GPS, Bluetooth beacons, Wi-Fi triangulation, or optical markers to identify when a user enters a geolocated environment. Upon detection, the system retrieves relevant contextual data—such as store layouts or service details—and may organize user task data by mapping items to locations and computing an optimized path based on proximity.

The persona adaptation module stores multiple persona templates and selects an appropriate persona based on location and context. Persona types may include mascots associated with retail environments, task-specific assistants, or instructional guides capable of delivering sequenced task support. This approach ensures that the virtual companion engages the user with an interaction style suited to the task and environment.

In some embodiments, the emotional intelligence module fuses data from facial expression analysis, voice tone, and physiological parameters to determine user emotional states. This module may employ trained machine learning models to recognize and classify affective cues, improving detection accuracy over time through continuous learning.

The cognitive adaptive learning module responds to detected stress or frustration by selecting intervention strategies from a predefined set, tailoring them based on historical user response data. Available strategies include task complexity modulation, motivational feedback, sensory regulation techniques, and guided breathing exercises.

Secure communication is implemented using quantum key distribution protocols to establish encrypted channels between the user device and client systems. This architecture supports secure data transmission during transitions between environments, protecting sensitive user data against both conventional and quantum-enabled threats.

The system is operable across multiple output platforms, including mobile phones, augmented and virtual reality headsets, smart speakers, and wearable devices with haptic feedback, facilitating user interaction across preferred modalities. The rendering module adjusts the representation of the virtual companion based on output device capabilities, optimizing dimensionality and fidelity as appropriate.

The backend platform aggregates anonymized user interaction data and updates behavioral models based on usage trends. This continuous improvement mechanism refines assistance strategies over time in response to real-world performance.

In some embodiments, the processor detects completion of a task in one environment and identifies related follow-up tasks in a second environment, maintaining task continuity during the transition. For example, after assisting with item selection in a retail setting, the system may provide cooking instructions at home.

In further embodiments, an edge computing module supports local processing of time-sensitive data, reducing latency and ensuring continued functionality during periods of limited network connectivity. This distributed approach enhances reliability and responsiveness.

The system supports multiple modes of operation, including retail navigation, task-specific guidance, emotional support, and interactive skill training. A modular integration framework enables communication with smart home devices, point-of-sale terminals, transportation systems, and productivity tools, further expanding the scope of assistance available to users.

The invention also encompasses a method for providing adaptive assistance. The method includes detecting entry into a geolocated environment, establishing secure communication, processing multimodal input data, selecting a context-appropriate persona, determining the user's emotional state, providing real-time task guidance, and maintaining context across transitions between environments. The method enables, context-sensitive support tailored to both the user's objectives and emotional well-being.

### BRIEF DESCRIPTION OF THE DRAWINGS

Various embodiments of the invention are disclosed in the following detailed description and accompanying drawings.

FIG. 1 illustrates an example geolocation-based detection and interaction process in a retail environment.

FIG. 2 illustrates an example dynamic persona adaptation process of a virtual companion in response to a user request.

FIG. 3 illustrates an example secure communication architecture using quantum key distribution protocols.

FIG. 4 illustrates an example process for transitioning virtual companion assistance from a public to a private environment

FIG. 5 illustrates an example system architecture showing component modules and data flow across system layers.

FIG. 6 illustrates an example use-case of the system assisting a user with navigation and decision-making in a grocery store.

FIG. 7 illustrates an example use-case of the system assisting a user in a home kitchen environment following a public-to-private transition.

FIG. 8 illustrates an example workflow for multimodal data processing and adaptive response generation.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used to distinguish different elements or features, but these elements or features should not be limited by these terms. A first element or feature described can be referred to as a second element or feature and vice versa without departing from the teachings of the present disclosure.

The term “context awareness engine” refers to a system component configured to collect, analyze, and process environmental and situational data to determine a user's current context. Such data may include, but is not limited to, geolocation information, environmental sensor inputs, integration with external client systems, and retrieval of context-relevant data. In one exemplary implementation, the context awareness engine may utilize GPS coordinates in conjunction with Bluetooth beacon signals to detect a user's presence within a specific retail store, and may further retrieve store layout and product information from a backend system associated with that store.

The term “multimodal input data” refers to data derived from a plurality of sensing modalities that collectively provide information about a user's physical state, emotional state, behavior, or interactions with the system. Such data may include, but is not limited to, geolocation signals, visual data captured via cameras, audio data captured via microphones, motion data from accelerometers or position sensors, and biometric data obtained from physiological sensors. In one example, multimodal input data may include concurrent collection of facial expression video, voice recordings, hand motion tracking, and heart rate signals during a user's navigation of a shopping environment.

The term “virtual companion” refers to an artificially intelligent entity generated by the system for user interaction, configured to communicate through one or more modalities including visual, auditory, and haptic channels. The virtual companion may be embodied as an animated character, voice assistant, text-based interface, or abstract representation capable of providing task guidance, emotional support, or context-aware interaction. For example, the virtual companion may be presented as a retailer's mascot on a user's mobile device, providing product navigation and verbal instructions during a shopping task.

The term “persona adaptation module” refers to a system component configured to manage and modify the appearance, behavior, and interaction style of the virtual companion in accordance with environmental context and user-specific needs. The module may operate by selecting from a set of predefined persona templates and adjusting communication tone, visual representation, or behavioral logic accordingly. In one implementation, the module may transition the virtual companion from a general-purpose store assistant to a chef persona in response to a user's request for recipe guidance, modifying the persona's vocabulary, appearance, and subject matter expertise.

The term “emotional intelligence module” refers to a system component configured to interpret and evaluate the emotional state of the user based on multimodal input data. The module may analyze facial expressions, voice characteristics, behavioral indicators, and physiological signals to detect emotional cues. For instance, the module may identify signs of user frustration during a cooking task by detecting furrowed brows, stress-induced voice modulation, and elevated heart rate, and may initiate a corresponding intervention based on this analysis.

The term “cognitive adaptive learning module” refers to a component of the system configured to select, adapt, and deliver intervention strategies tailored to the user's current emotional state and historical behavior. Such strategies may include, but are not limited to, task simplification, motivational feedback, sensory regulation, and guided relaxation techniques. In one example, upon detecting user anxiety in a crowded environment, the module may initiate a five-step breathing exercise, adjusting parameters based on the user's prior response to similar interventions.

The term “quantum encryption protocols” refers to cryptographic methods based on the principles of quantum mechanics, configured to secure data transmission between system components. Such protocols may include, without limitation, quantum key distribution (QKD), quantum random number generation, and post-quantum cryptographic algorithms. In one exemplary case, QKD may be used to securely transmit encryption keys between a user's mobile device and a client system within a retail environment, leveraging quantum photon transmission over a fiber optic channel.

The term “backend platform” refers to a cloud-based infrastructure supporting the storage, processing, and synchronization of data within the system. The backend platform may include database systems, analytics engines, server-side processing units, and synchronization mechanisms. In one embodiment, the backend platform comprises a distributed database architecture operating on containerized microservices, configured to process user interaction logs, store environmental metadata, and maintain consistent user profiles across multiple devices and locations.

The term “rendering module” refers to a system component configured to generate and deliver the perceptual representation of the virtual companion through one or more output modalities, including but not limited to visual, auditory, and haptic interfaces. The rendering module may comprise graphics engines, speech synthesis systems, animation subsystems, and haptic feedback controllers. In one example, the rendering module may generate a three-dimensional virtual character rendered in augmented reality, complete with synchronized lip movements, gestures, and voice output delivered through a headset device.

### Description of Drawings

The present invention provides a system and method for delivering adaptive assistance across a variety of environments, addressing the limitations of conventional assistive technologies through the integration of context awareness, emotional intelligence, and secure inter-environment transitions. Unlike existing systems that typically operate within confined or static settings, the invention enables continuous, personalized support as a user moves between public environments (e.g., retail venues, transportation hubs) and private domains (e.g., residential settings).

At the core of the invention is an integrated system architecture that includes a context awareness engine, a dynamic virtual companion, an emotional intelligence module, and a secure communication interface utilizing quantum encryption protocols. This unified architecture overcomes the fragmentation often associated with current assistive solutions by maintaining consistency of interaction, adapting in real time to environmental and emotional contexts, and facilitating secure continuity of assistance without requiring users to shift between separate applications or platforms.

The context awareness engine enables the system to identify the user's current physical environment and retrieve context-specific data relevant to that setting. This may include, for example, geolocation information obtained via GPS, local signals detected through Bluetooth beacons, or Wi-Fi triangulation data. Upon detecting that a user has entered a known location, the system may establish a secure connection with a client system associated with that environment (e.g., a retail store's backend system), enabling the retrieval of location-specific data such as store layout, product availability, or service information. In one exemplary use case, the system may optimize a user's navigation through a grocery store by generating a shopping route based on the store's inventory and layout.

A key advancement of the invention lies in the persona adaptation capability of the virtual companion. Unlike traditional systems that maintain a static interaction model, the virtual companion dynamically transitions between context-specific personas to better align with user needs and environmental characteristics. For example, the companion may adopt a mascot persona while assisting in a retail setting and ly transition to a chef persona when providing culinary guidance. These personas differ in visual representation, interaction style, and domain-specific knowledge, thereby enabling more intuitive and relevant assistance for the user.

The emotional intelligence module, in conjunction with the cognitive adaptive learning module, provides robust emotional context processing by analyzing multimodal input data, including facial expressions, voice tone, behavioral cues, and physiological signals. These modules are configured to detect indicators of user frustration, stress, confusion, or other affective states, and to respond by adjusting the system's behavior. Responsive strategies may include simplifying task instructions, offering motivational feedback, or initiating calming interventions such as guided breathing exercises. This capability is particularly beneficial for users with emotional regulation challenges, sensory processing difficulties, or other cognitive needs.

The invention also addresses the challenge of maintaining continuity of assistance across distinct environments. For example, after assisting a user in a grocery store, the system may detect that the user has transitioned to a residential setting and continue offering guidance relevant to the previous task—such as meal preparation instructions for the items purchased. This transition is supported through secure synchronization of task data, contextual history, and user preferences between environments, ensuring that the assistance remains cohesive and uninterrupted.

To address privacy and data security concerns, the system employs quantum encryption protocols, including but not limited to Quantum Key Distribution (QKD). These protocols enable the secure transmission of sensitive user data—such as preferences, behavioral history, and task records—between user devices, client systems, and the backend platform. By leveraging cryptographic techniques that are resistant to both classical and quantum computing attacks, the invention ensures a high level of trust and data integrity, particularly in public or unsecured networks.

The modular system design supports deployment across a wide array of output modalities, including mobile devices, augmented reality (AR) headsets, virtual reality (VR) systems, smart speakers, and wearable devices with haptic feedback. This flexibility enables the virtual companion to be rendered and interacted with in a form that is both accessible and contextually appropriate for the user and environment.

Through the integration of these features, the invention enables users—particularly those with cognitive, emotional, or physical challenges—to navigate complex environments, perform multi-step or unfamiliar tasks, and receive adaptive support that responds to both their surroundings and affective states. The following sections provide a detailed description of exemplary implementations of the system's components, along with illustrative scenarios demonstrating its operation across different contexts.

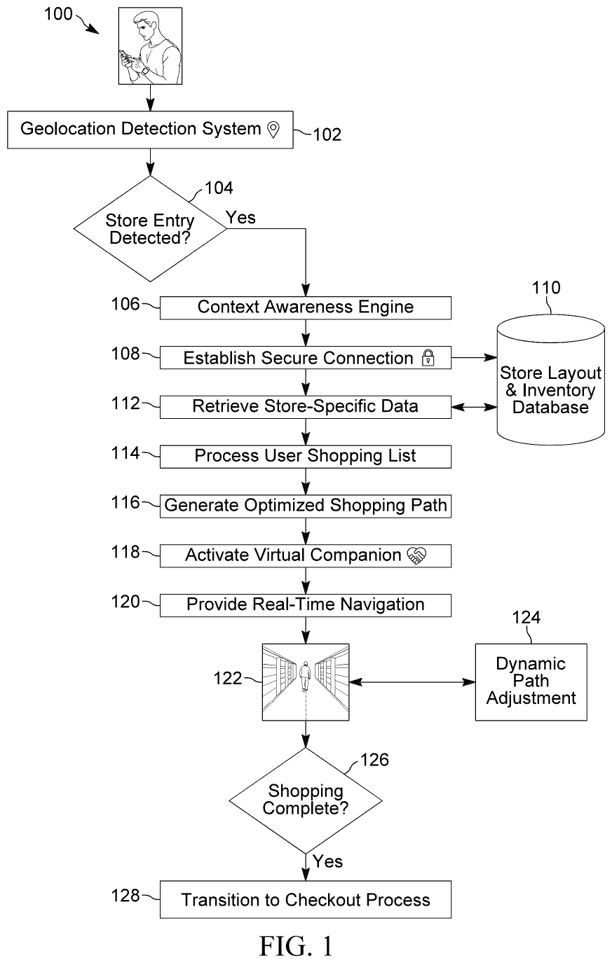

Referring now to the drawings, FIG. 1 illustrates a flowchart representing a geolocation-based detection and interaction process within a grocery store environment, in accordance with an embodiment of the present invention.

The process begins when a user (100), carrying a mobile device, enters the vicinity of a retail environment. A Geolocation Detection System (102) continuously monitors the user's position using one or more localization technologies, which may include, but are not limited to, GPS signals, Wi-Fi triangulation, Bluetooth beacons, or indoor positioning systems.

Upon approach or entry into a supported retail location, the system executes a store entry detection operation (104). This operation functions as a conditional decision point. If entry into a supported environment is not detected, the system continues to monitor the user's location. If entry is positively detected, the system activates a Context Awareness Engine (106).

Following activation, the Context Awareness Engine initiates a secure connection establishment operation (108) with one or more systems associated with the retail environment. This connection is secured using Quantum Key Distribution (QKD) protocols to ensure encrypted and tamper-resistant communication of sensitive user and environmental data.

Once a secure connection is established, the system accesses a Store Layout and Inventory Database (110). This database contains environment-specific data, including store layout schematics, product locations, inventory availability, and active promotional offerings.

The system then performs a data retrieval operation (112) to obtain store-specific data relevant to the user's shopping experience. Retrieved data may include, by way of example, real-time stock levels, personalized recommendations, or discount information tailored to the user's historical preferences.

Subsequently, the system processes the user's shopping list (114), which may be preloaded or input upon arrival. This processing includes parsing list items, identifying corresponding products in the store inventory, and associating those products with specific store locations.

Based on the processed shopping list and environmental data, the system generates an optimized shopping path (116). This path accounts for factors such as item proximity, store layout, localized congestion, and user-defined shopping preferences to improve efficiency and reduce cognitive load.

The system then activates the Virtual Companion (118), which serves as the user-facing interface. The Virtual Companion may be rendered as a store-branded character or mascot and is configured to convey navigation instructions and contextual product information through one or more output modalities (e.g., mobile display, AR overlay, voice prompts).

The Virtual Companion delivers real-time navigation guidance (120) to direct the user to each item on the shopping list according to the optimized path. As the user progresses through the environment (122), the system continuously monitors their position and activity to ensure alignment with the suggested route.

If deviations occur or conditions change, the system performs dynamic path adjustment operations (124). These may be triggered by real-time events such as aisle congestion, unexpected user detours, or the addition of new shopping list items, prompting recalculation of the navigation path.

Throughout the process, the system monitors task progress via a path completion detection operation (126). If items remain on the list, guidance continues. Upon determination that the shopping list has been completed, the system initiates checkout guidance (128), directing the user to an appropriate checkout terminal and optionally interfacing with payment or point-of-sale systems.

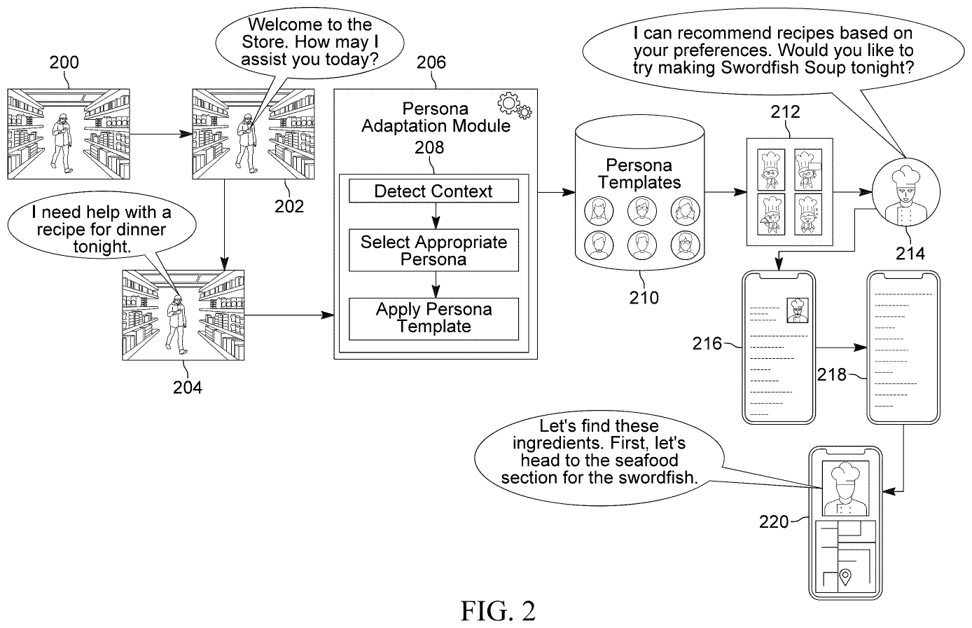

FIG. 2 illustrates a diagram of a dynamic persona adaptation process executed by a Virtual Reality Artificial Intelligence Companion (VRAIC) within a retail environment, in accordance with an embodiment of the present invention. The diagram depicts a representative sequence through which the VRAIC transitions from a general-purpose mascot persona to a specialized chef persona in response to a user-initiated request.

As shown in the left portion of the diagram, a user (200) interacts with the system via a mobile device while present within a retail environment. Initially, the VRAIC is rendered as a mascot persona (202) associated with the retail brand or environment. This mascot persona functions as the default interface, providing general-purpose guidance, welcoming the user, and offering basic navigational or informational support via graphical elements such as text bubbles or speech synthesis. The mascot may incorporate store-specific branding, voice characteristics, and simplified interaction protocols.

During this initial interaction, the user submits a recipe assistance request (204). This request may be initiated through one or more input modalities, including voice commands, typed text, or selection from a graphical user interface. Upon receiving the request, the system invokes a Persona Adaptation Module (206) to manage the persona transition process.

The Persona Adaptation Module initiates a persona selection operation (208), which includes contextual recognition of the request (e.g., culinary assistance), identification of a matching persona archetype (e.g., virtual chef), and retrieval of a corresponding persona template. This operation is performed by interfacing with a Persona Database (210) that stores a plurality of predefined persona templates, each comprising specifications for appearance, behavioral characteristics, knowledge domains, and interaction styles.

Upon template selection, the system executes a persona transition animation (212) to visually communicate the persona change. The transition may be rendered using morphing sequences, fade effects, or other animation techniques to transform the mascot persona into the specialized chef persona in a manner that is perceptible and intuitive to the user.

Following the transition, the VRAIC is rendered as a chef persona (214), visually characterized by elements such as culinary attire, cooking utensils, or thematic coloration. The chef persona is configured to operate with domain-specific knowledge and presents one or more recipe options to the user, potentially tailored to user preferences, seasonal availability, or items already selected during the shopping session.

Upon user selection of a recipe, the system generates a Recipe Recommendation Interface (216) that displays recipe-specific details, such as estimated preparation time, complexity level, ingredient list, and any relevant dietary notes. The user may then confirm a selection, prompting the system to execute an Ingredient List Generation (218) operation. This operation produces a structured list of required ingredients, associated quantities, and possible substitutions, formatted for display and integration with in-store navigation.

Subsequently, the chef persona provides navigation guidance (220) specific to the selected recipe. This guidance includes directional cues to store locations where the listed ingredients are available, along with context-relevant culinary insights (e.g., ingredient quality indicators, usage tips, or suggested alternatives).

Throughout the persona adaptation process, data flow connections (222) are maintained between all relevant system components, including the context awareness engine, user preference memory, and backend data store. These connections preserve continuity of interaction, ensuring that shopping history, prior selections, and environmental context are retained across persona transitions.

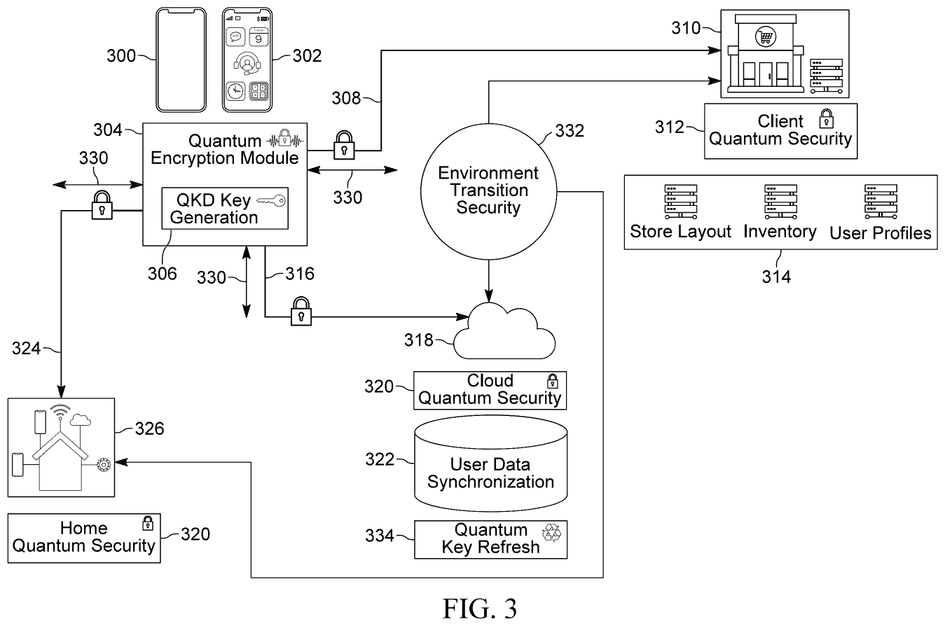

FIG. 3 illustrates a schematic diagram of the secure communication architecture employed by the system, showing how user data is protected during transmission between system components across multiple environments, in accordance with an embodiment of the present invention. The architecture leverages Quantum Key Distribution (QKD) protocols to ensure data privacy, integrity, and resistance to both classical and quantum computational threats.

In the upper left portion of the diagram, a User Device (300)—which may be implemented as a smartphone, tablet, or other personal computing device—serves as the primary interface through which the user interacts with the system. The device hosts a Mobile Application Interface (302) that presents the virtual companion and provides interactive functionality for receiving guidance, entering commands, and displaying context-specific information.

Positioned below the User Device is a Quantum Encryption Module (304), which implements the system's quantum-secured communication protocols. Within this module, a QKD Key Generation component (306) produces encryption keys based on quantum mechanical phenomena, enabling key exchanges that are inherently resistant to interception or computational compromise.

A Secure Communication Channel A (308) extends from the Quantum Encryption Module to a Geolocated Client System (310) representing infrastructure within a public environment, such as a retail store. This channel is used to transmit data including user preferences, shopping lists, and geolocation information. The Geolocated Client System includes a Client Quantum Security Layer (312) for decrypting and securing inbound data. Below this layer, a set of Store Data Processors (314) manages environment-specific information such as inventory, floor plans, and localized user profiles.

A second pathway, Secure Communication Channel B (316), connects the Quantum Encryption Module to a Cloud Backend Platform (318), enabling the synchronization of user data across environments. The Cloud Backend Platform includes a Cloud Quantum Security Layer (320) and a Synced User Data Storage (322) module that stores preferences, interaction history, and task-related data to support consistent system behavior over time and across locations.

On the left side of the diagram, Secure Communication Channel C (324) links the Quantum Encryption Module to a Private Environment System (326)—representing the user's personal space, such as their home. This system incorporates a Home Quantum Security Layer (328), which mirrors the encryption protocols used in public-facing infrastructure to ensure and secure continuity of service as the user transitions between environments.

Data Flow Indicators (330) throughout the diagram represent bidirectional information exchange across the secured channels, illustrating how user data moves between mobile, client, backend, and private systems under persistent encryption.

Centrally positioned in the architecture is an Environment Transition Security component (332), which manages the secure transfer of context and assistance continuity as the user moves between distinct physical locations. This component ensures that sensitive data remains protected while allowing the virtual companion and assistance logic to persist across transitions.

Finally, a Quantum Key Refresh Mechanism (334) is shown near the lower portion of the diagram. This mechanism is configured to periodically regenerate encryption keys, limiting key lifespan and further reducing exposure risk in the event of any attempted compromise.

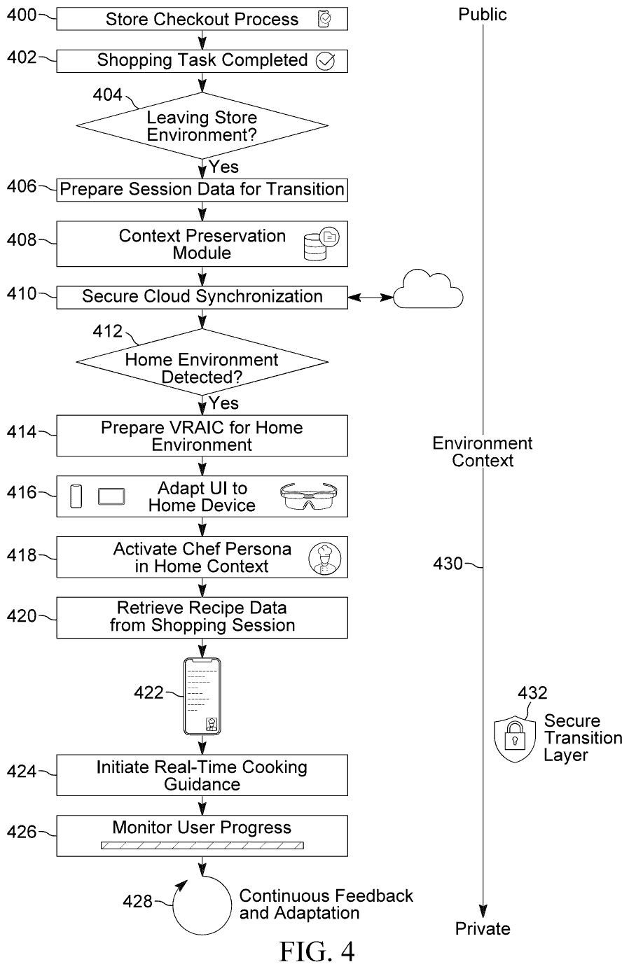

Referring to FIG. 4, a flowchart illustrates the public-to-private environment transition process of the Virtual Reality Artificial Intelligence Companion (VRAIC) according to an embodiment of the present invention. The diagram depicts the sequence of operations that enable continuous assistance as a user moves from a retail environment to their home.

The process begins at the top of the diagram with the Store Checkout Process (400), representing the final phase of the user's retail experience. This process may include conventional checkout activities such as scanning items, payment processing, and receipt generation, all potentially enhanced by system guidance.

Following checkout completion, the system registers Shopping Task Completion (402), marking the conclusion of the primary retail assistance scenario. This step serves as a trigger point for preparation of the transition to subsequent assistance phases.

The system then performs Environment Transition Detection (404), a decision point that determines whether the user is leaving the retail environment. This detection may utilize geolocation signals, disconnection from store Wi-Fi networks, or explicit user indication. If the system determines the user is not yet leaving the environment, it maintains the current assistance mode.

When the system detects that the user is leaving the retail environment, it initiates Session Data Preparation (406). This step involves organizing and packaging all relevant data from the shopping session, including purchased items, selected recipes, and interaction preferences, to enable continuity of assistance beyond the retail setting.

The Context Preservation Module (408) then processes this data to maintain contextual continuity during the environment transition. This module identifies which elements of the shopping experience should persist into subsequent assistance scenarios, such as recipe instructions related to purchased ingredients.

To ensure data availability across environments, the system performs Secure Data Synchronization (410) with cloud storage. This operation encrypts session data using quantum security protocols and transfers it to the cloud backend, where it becomes accessible to authorized devices in other environments.

As the user travels from the retail environment to their home, the system monitors location data to perform Home Environment Detection (412). This decision point determines whether the user has arrived at their home location, which may be identified through geofencing, connection to home Wi-Fi networks, or direct user indication.

Upon detecting the home environment, the system initiates VRAIC Transition Preparation (414), readying the virtual companion for operation in the new context. This preparation includes adjusting assistance parameters to match the home environment and retrieving synchronized session data from the cloud.

The User Interface Adaptation process (416) modifies the presentation of the virtual companion to suit the available devices in the home environment. This adaptation may involve transitioning from a mobile phone interface to a tablet, smart display, augmented reality glasses, or other home devices, with appropriate adjustments to visual elements and interaction modalities.

The system then performs Chef Persona Activation (418), ensuring that the specialized chef persona established during the shopping experience remains active and consistent in the home environment. This continuity of persona helps maintain the user's contextual understanding and relationship with the virtual companion.

To support ongoing assistance, the system executes Recipe Data Retrieval (420), accessing detailed recipe information related to the items purchased during the shopping session. This data includes preparation instructions, cooking times, techniques, and other culinary guidance.

The system then generates a Step-by-Step Cooking Interface (422) on the appropriate home device. This interface presents detailed cooking instructions in a sequential format with visual aids, timing information, and technique demonstrations as appropriate for the selected recipe.

Upon user readiness, the system initiates Real-Time Guidance (424), beginning the interactive cooking assistance process. This guidance provides synchronized instructions that adapt to the user's pace and responds to voice commands or gestures for hands-free operation during food preparation.

Throughout the cooking process, the system performs continuous Progress Monitoring (426), tracking the user's advancement through recipe steps. This monitoring may utilize various inputs including elapsed time, user confirmations, computer vision analysis of food state, or integration with smart kitchen appliances.

The system maintains a continuous User Feedback Loop (428) at the bottom of the process flow, collecting and responding to user interactions throughout the cooking experience. This feedback mechanism enables real-time adjustments to guidance based on user questions, difficulties encountered, or changes to the preparation process.

Running vertically along the diagram, the Environment Context Link (430) visually represents the contextual continuity maintained as the user transitions from the public retail environment to the private home environment. This component illustrates how context, persona, and task information persist despite the physical environment change.

Operating at the transition point between environments, the Transition Security Layer (432) ensures that all data remains protected during the environment change. This security component implements quantum encryption protocols to maintain data privacy as information moves between public and private contexts.

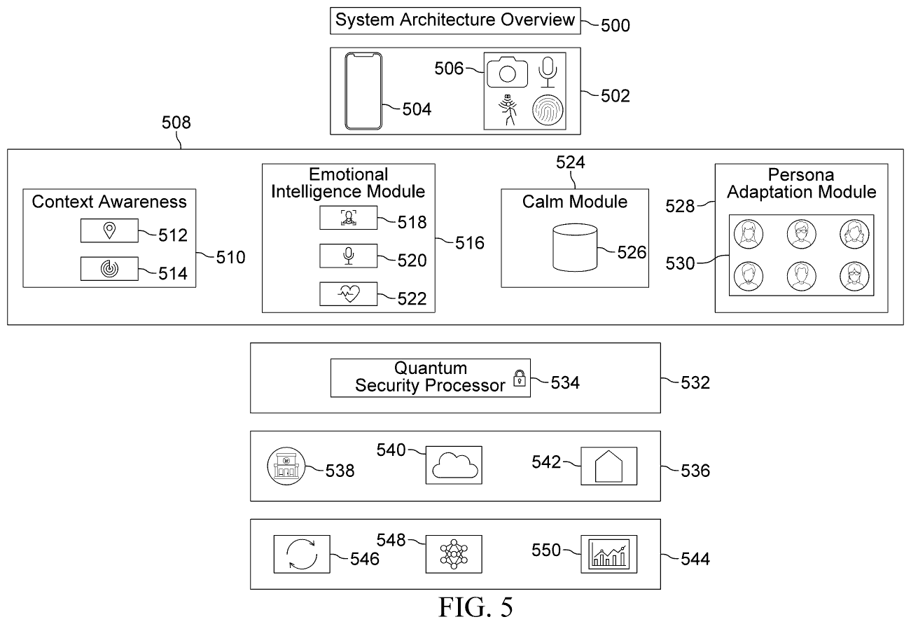

Referring to FIG. 5, a block diagram illustrates the comprehensive system architecture of the adaptive assistance system according to an embodiment of the present invention. The diagram depicts the hierarchical organization of the system components and their logical interconnections, with the System Architecture Overview (500) positioned at the top of the diagram as a title element.

The architecture is organized into multiple functional layers, beginning with the User Layer (502) at the top of the main diagram area. This layer encompasses the interface components through which the user interacts with the system. Within this layer, the User Device (504) represents the physical hardware (such as smartphones, tablets, or wearable devices) that serves as the primary interface point. Adjacent to the User Device, the User Input Sensors (506) comprise various data collection mechanisms including cameras for visual input, microphones for audio capture, motion sensors for gesture detection, and biometric sensors for physiological measurements.

Below the User Layer, the Core Processing Layer (508) contains the primary computational components responsible for data analysis and system behavior generation. This layer houses multiple specialized modules that work in concert to provide adaptive assistance.

Positioned on the left side of the Core Processing Layer, the Context Awareness Engine (510) analyzes environmental factors and user location to establish situational context. Within this engine, the Geolocation Detection Module (512) processes position data to identify the user's location and environment type (such as retail store, transportation hub, or home setting). The Environmental Analysis Module (514) interprets ambient conditions and physical surroundings to further refine contextual understanding.

In the center-left area of the Core Processing Layer, the Emotional Intelligence Module (516) interprets the user's affective state through multimodal analysis. This module contains specialized components including the Facial Analysis Component (518), which processes visual data to recognize expressions and emotional indicators; the Voice Analysis Component (520), which extracts emotional cues from speech patterns and tonal qualities; and the Biometric Signal Processing component (522), which interprets physiological measurements such as heart rate variability or electrodermal activity to assess emotional arousal and stress levels.

Positioned in the center-right area of the Core Processing Layer, the Cognitive Adaptive Learning for Mediation (CALM) Module (524) generates appropriate intervention strategies based on detected emotional states and contextual factors. This module incorporates an Intervention Strategy Database (526) containing parameterized approaches for emotional regulation, stress reduction, and motivation enhancement that can be customized to individual user needs.

On the right side of the Core Processing Layer, the Persona Adaptation Module (528) manages the appearance, behavior, and interaction style of the virtual companion. This module contains Persona Templates (530) representing different specialized assistants (such as store guides, chef personas, or transportation navigators) that can be deployed based on environmental context and task requirements.

Below the Core Processing Layer, the Communication Layer (532) manages data transmission between system components and external systems. Within this layer, the Quantum Security Processor (534) implements advanced encryption protocols, particularly Quantum Key Distribution (QKD), to ensure secure data transmission across all communication channels.

The Environment Interface Layer (536) positioned below the Communication Layer establishes connections with different environmental contexts. This layer contains specialized interfaces for different settings: the Geolocated Client Interface (538) manages connections with retail or public location systems; the Cloud Backend Interface (540) facilitates communication with the system's cloud infrastructure; and the Private Environment Interface (542) establishes connections with the user's home systems and smart devices.

At the bottom of the architecture diagram, the Backend Platform Layer (544) provides cloud-based processing and storage capabilities that support system operation across environments. Within this layer, the User Data Synchronization component (546) maintains consistent user information across devices and locations; the Behavioral Model Processing component (548) continuously refines system behavior based on interaction patterns; and the System Analytics Engine (550) processes aggregated usage data to identify improvement opportunities.

Throughout the diagram, Data Flow Connections (552) illustrate the transmission paths between components, showing how information moves through the system. These connections include solid lines representing direct internal pathways and dashed lines indicating wireless or cloud-based connections.

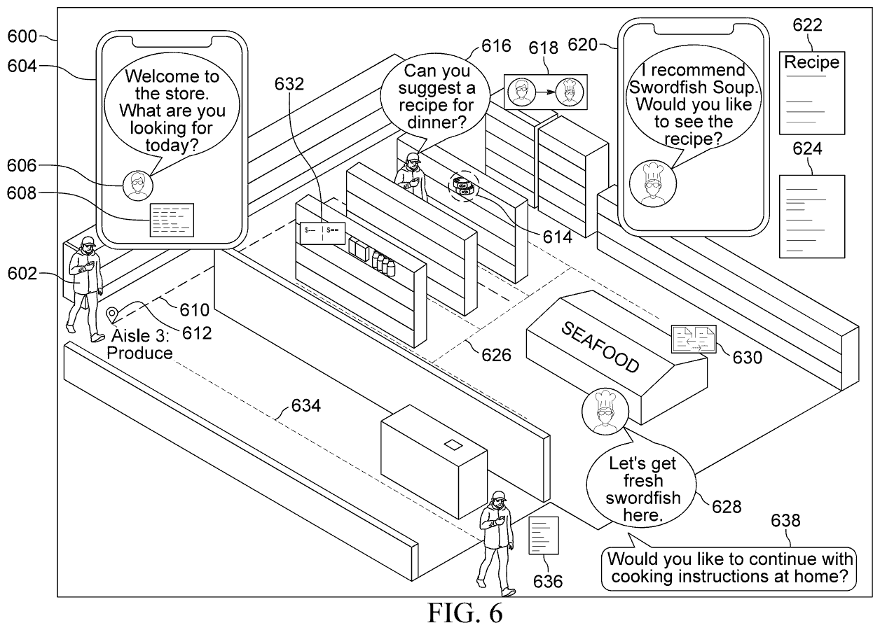

Referring to FIG. 6, a use-case diagram illustrates a user navigating a grocery store with the assistance of the Virtual Reality Artificial Intelligence Companion (VRAIC) system according to an embodiment of the present invention. The diagram depicts a practical implementation of the system's capabilities within a retail environment.

The diagram utilizes a Store Layout Background (600) as its primary backdrop, showing a simplified top-down view of a grocery store with distinct sections and aisles. This layout provides spatial context for the illustrated user interaction sequence and demonstrates how the system provides navigation within a physical retail environment.

Positioned near the store entrance, a User FIG. (602) represents an individual utilizing the system while shopping. Adjacent to the user figure, a Mobile Device Screen (604) displays an enlarged view of the interface through which the user interacts with the VRAIC. This interface serves as the primary communication channel between the user and the virtual companion.

Within the mobile device screen, the VRAIC Mascot Representation (606) appears as the store's branded character, establishing the initial persona that welcomes the user and offers general assistance. The mascot provides conversational engagement through speech bubbles or text displays, creating an approachable entry point to the assistance system.

Below the mascot representation, a Shopping List Display (608) shows the user's intended purchases organized in a digital format. This list may be pre-populated before the store visit or created upon arrival, serving as the primary data source for navigation guidance.

Extending from the user's position through the store layout, a Navigation Path Visualization (610) appears as a colored line indicating the optimized route for collecting items. This path is generated by the system based on item proximity, store layout efficiency, and user preferences, guiding the user through the shopping experience in a logical sequence.

At the first navigation waypoint, an Aisle Guidance Indicator (612) highlights a specific store section, demonstrating how the system directs the user to particular locations. This indicator includes both visual highlighting and contextual information about the products available in that section.

Within the highlighted aisle, a Product Location Highlight (614) pinpoints the exact shelf position of a specific item from the shopping list. This precise localization reduces search time and cognitive load by eliminating the need for the user to scan shelves for products.

Further along the navigation path, a Recipe Request Interaction (616) shows the user initiating a specialized assistance request through a speech bubble or text input. This interaction demonstrates how the system responds to dynamic user needs that arise during the shopping experience.

Adjacent to the recipe request, the VRAIC Persona Transition (618) illustrates the transformation process from the store mascot to a specialized chef persona. This sequence visualizes how the system adapts its interface and expertise to provide domain-specific assistance based on user requests.

Following the transition, the Chef Persona Interface (620) shows the updated virtual companion with culinary-specific attributes and knowledge. This specialized persona offers expert-level guidance related to meal preparation and ingredient selection, demonstrating the system's adaptability to different assistance domains.

Next to the chef persona, a Recipe Display (622) shows detailed information about a suggested recipe, including ingredients, preparation time, and difficulty level. This display illustrates how the system provides contextual recommendations based on user preferences and shopping history.

Below the recipe display, an Ingredient List Generation (624) shows the automatic creation of a shopping sub-list specific to the selected recipe. This generated list demonstrates the system's ability to decompose complex tasks (meal preparation) into component actions (ingredient acquisition).

Extending from the user's current position, a Path Recalculation Indicator (626) shows the generation of a revised navigation route to accommodate the newly added recipe ingredients. This recalculation demonstrates the system's dynamic adaptation to changing user objectives during the shopping session.

At the seafood counter location in the store layout, the Seafood Section Guidance (628) shows the chef persona providing specialized assistance related to seafood selection. This specialized guidance illustrates how the system delivers contextually appropriate expertise at relevant locations within the store.

Adjacent to the seafood counter, a Geolocated Inventory Check (630) illustrates the data exchange between the VRAIC system and the store's inventory management system. This interaction demonstrates how the system integrates with existing retail infrastructure to access real-time product availability information.

Near a product section, a Real-time Price Comparison (631) shows the system providing contextual pricing information to assist with purchase decisions. This feature demonstrates how the system enhances shopping efficiency by providing relevant comparative data at the point of decision.

Approaching the store checkout area, the Checkout Navigation (634) shows the final segment of the guidance path leading to payment processing. This element illustrates how the system provides comprehensive assistance throughout the entire shopping journey, including the transaction completion phase.

At the store exit, a Session Completion Indicator (636) displays a summary of the shopping experience, including items purchased and recipe information. This summary demonstrates how the system provides closure for the public environment phase of assistance.

At the bottom of the diagram, a Public-to-Private Transition Prompt (638) illustrates the system's suggestion to continue assistance in the user's home environment. This prompt demonstrates the continuity capability that distinguishes the system from conventional single-environment assistance solutions.

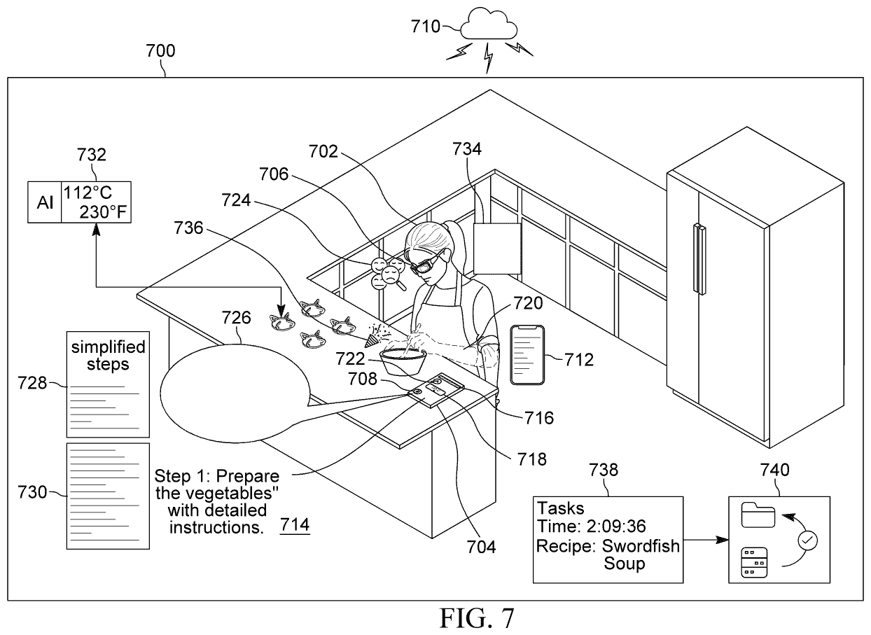

Referring to FIG. 7, a use-case diagram illustrates the VRAIC system providing assistance to a user in a private home environment according to an embodiment of the present invention. The diagram depicts the continuity of assistance from the grocery store to the home setting, with particular focus on meal preparation guidance.

The diagram uses a Home Kitchen Setting (700) as its primary backdrop, showing a simplified side view of a kitchen environment with common elements including a counter, stove, and refrigerator. This setting establishes the private context in which the system continues to provide assistance following the public retail environment interaction.

Positioned centrally within the kitchen environment, a User Figure at Home (702) represents the individual engaging with the system while preparing food at the counter. This figure illustrates how the system supports practical tasks within the home environment, maintaining assistance continuity across location transitions.

Placed on the kitchen counter near the user, a Mobile Device on Counter (704) displays the system interface, showing how conventional personal devices serve as access points for the virtual companion in the home environment. This device may be positioned on a stand or holder to facilitate hands-free viewing during food preparation activities.

As an alternative or complementary interface, AR Glasses (706) are shown on the user figure, representing the augmented reality implementation of the system. These glasses enable spatial computing capabilities that overlay virtual elements onto the physical environment, allowing for hands-free guidance during manual tasks.

Present on both the mobile device display and as an augmented reality projection, the Chef Persona Continuation (708) shows the same virtual chef character that was established in the retail environment. This visual continuity demonstrates how the system maintains persona consistency across environment transitions, preserving relationship context and user familiarity.

At the top of the diagram, a Recipe Data Transfer Indicator (710) illustrates the cloud-based synchronization that enables data continuity between environments. This component represents the secure transmission of recipe information, shopping data, and user preferences from the retail session to the home environment.

Near the kitchen counter, an Ingredient Organization Display (712) shows a virtual interface organizing the purchased ingredients according to their use in the recipe. This organization demonstrates how the system helps users transition from shopping to preparation by logically arranging items based on preparation sequence.

Prominently displayed on the mobile device or projected through AR, a Step-by-Step Instruction Panel (714) provides detailed guidance for the current cooking task. This panel demonstrates how the system breaks complex food preparation procedures into manageable steps with specific instructions for each phase.

At the bottom of the instruction panel, a Progress Tracking Bar (716) visualizes the user's advancement through the recipe. This tracking element illustrates how the system maintains awareness of task completion and adapts subsequent guidance based on current progress.

Adjacent to the instruction panel, a Timer Function (718) shows the system's ability to manage time-sensitive cooking operations. This function demonstrates integration of temporal guidance with procedural instructions, ensuring proper cooking durations for optimal results.

Near the user's hands, a Technique Demonstration (720) illustrates how the system provides visual guidance for specific cooking methods through augmented reality overlays or video demonstrations. This feature shows how the system addresses skill development alongside procedural guidance.

Near a completed preparation step, a Real-Time Feedback Indicator (722) shows the system's acknowledgment of task completion. This feedback mechanism demonstrates how the system maintains engagement through positive reinforcement and progress confirmation.

Positioned near the user's face, an Emotional State Detection (724) element subtly indicates the system's continuous monitoring of facial expressions and other emotional indicators. This monitoring illustrates the emotional intelligence capabilities that enable the system to adapt guidance based on affective state.

Connected to the emotional detection element, a Detected Frustration Response (726) shows the chef persona providing supportive feedback when user frustration is identified. This responsive element demonstrates how the system modifies its communication approach based on detected emotional states.

Adjacent to the frustration response, a Task Simplification Adaptation (728) shows modified instructions with reduced complexity. This adaptation illustrates how the system dynamically adjusts guidance difficulty based on emotional state and performance observations.

Near a successfully completed step, a Motivational Feedback Display (730) shows encouraging messages from the chef persona. This element demonstrates the system's incorporation of positive reinforcement to maintain engagement and build confidence throughout task execution.

Connected to the stove appliance, a Smart Appliance Integration (732) shows data exchange between the system and kitchen devices. This integration illustrates how the system can coordinate with IoT-enabled appliances to enhance guidance precision and automate monitoring of cooking conditions.

Positioned discretely in the corner of the interface, a Sensory Regulation Prompt (734) shows the availability of calming interventions if stress is detected. This element demonstrates the system's proactive emotional support capabilities that help maintain optimal user states during potentially stressful activities.

Near the finished dish, a Meal Completion Celebration (736) shows the chef persona providing congratulatory feedback. This celebratory element illustrates how the system recognizes achievement milestones and provides positive closure at task completion.

At the bottom right of the diagram, a Session Summary Screen (738) displays comprehensive information about the completed cooking task. This summary demonstrates how the system provides performance reflection and documentation of the completed activity.

At the very bottom of the diagram, a Continuous Learning Indicator (740) represents the system's recording of user preferences and adaptation points. This element illustrates the learning capabilities that enable increasingly personalized assistance through ongoing interaction analysis.

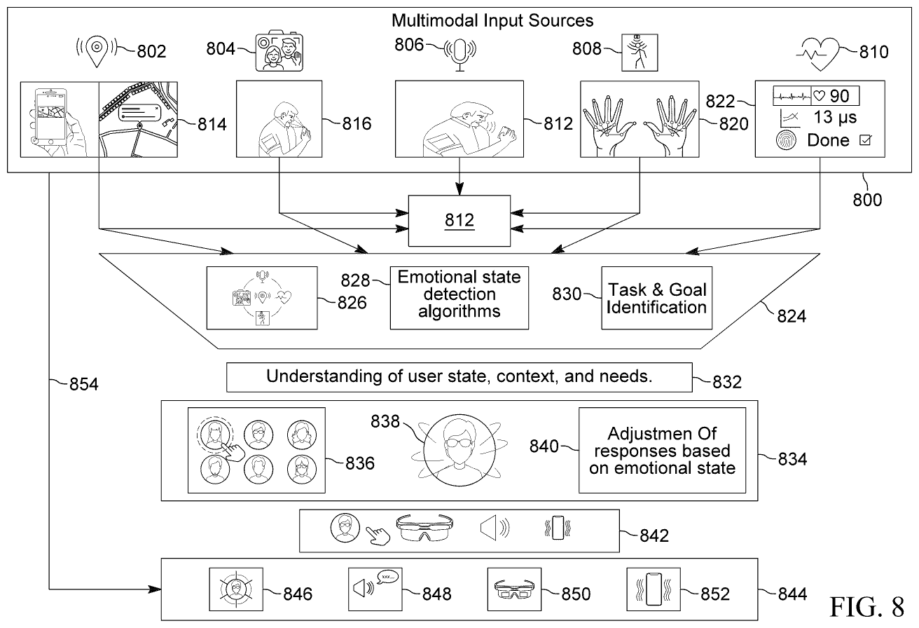

FIG. 8 illustrates a multimodal data processing workflow for generating adaptive system responses based on integrated user input, in accordance with an embodiment of the invention.

The system includes a User Input Layer (800) comprising multiple input sources configured to collect data from different modalities during user interaction. These input sources include a Geolocation Data Source (802) for determining the user's location, a Visual Input Source (804) for capturing image data such as facial expressions and gestures, a Voice Input Source (806) for receiving spoken commands and analyzing vocal tone, a Motion Input Source (808) for detecting user movement and activity, and a Biometric Input Source (810) for acquiring physiological signals such as heart rate or skin conductance.

Input data from each modality is transmitted to a Data Capture and Preprocessing Layer (812), where the data is parsed and prepared for higher-level interpretation. Within this layer, Geolocation Processing (814) identifies the user's environment, Computer Vision Processing (816) extracts visual features and facial cues, Speech Recognition Processing (818) interprets commands and tone, Motion Analysis Processing (820) detects activity patterns and gestures, and Physiological Signal Processing (822) evaluates biometric indicators for signs of stress or emotional variation.

Processed data is then forwarded to a Multimodal Fusion Layer (824), where inputs from the various processing modules are combined into a unified model of user state and context. This fusion layer includes a Context Integration Module (826) for correlating environmental data with user behavior, an Emotional State Classifier (828) for determining affective state, and a User Intent Analyzer (830) for inferring goals or task intent.

The output of the fusion layer is passed to a Comprehensive State Assessment Module (832), which generates a consolidated representation of the user's needs, emotional condition, and situational context.

Based on this assessment, a Response Generation Layer (834) selects and composes the system's adaptive output. This layer includes a Persona Selection Module (836) for determining the most appropriate virtual companion persona, a Content Generation Module (838) for producing task-specific instructions or recommendations, and an Emotional Response Adapter (840) for modulating the response delivery according to the user's emotional state.

A Delivery Modality Selector (842) determines the appropriate output channel(s) for presentation of the response, depending on available hardware and user preferences.

The system outputs are delivered via an Output Presentation Layer (844), which may include a Visual Output Channel (846), an Audio Output Channel (848), an Augmented Reality Visualization Channel (850), and a Haptic Feedback Channel (852).

A Feedback Loop Connection (854) links the output layer back to the input layer, enabling continuous monitoring of user reactions and updating of internal models in real time.

### Controller/Processor Components

A processor or controller as described herein may include any suitable type of computing device, such as a central processing unit (CPU), microcontroller, graphics processing unit (GPU), system on a chip (SoC), or digital signal processor (DSP). It may operate with one or more cores and may be configured to execute the functions described in this disclosure.

The processor may be operably connected to one or more memory devices, such as random access memory (RAM), read-only memory (ROM), flash storage, or solid-state drives (SSD). These memory devices store computer-readable instructions that, when executed by the processor, perform the methods described. The processor and memory communicate via data buses or other suitable communication pathways.

The computing device may also include input/output (I/O) devices, such as a touchscreen, mouse, keyboard, display, or speaker, to facilitate interaction with users or other systems. Additionally, it may include a network interface, such as a wired or wireless communication module, for connecting to networks.

Control logic or software instructions may be stored in memory and executed by the processor to implement specific functionalities. This logic may be modular, consisting of software components, processes, or functions that work together to perform the operations described herein.

The described computing operations involve the manipulation of data represented as electrical, optical, or magnetic signals stored or transferred within the system. These operations are machine-executed and do not require manual intervention, though they may interface with human operators through appropriate user interfaces.

The systems and methods described are not limited to any particular hardware configuration or programming language and may be implemented on general-purpose or specialized computing devices.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the . . . of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A system for providing context-aware adaptive virtual or augmented reality assistance, comprising:
a context awareness engine configured to detect a location of a user, analyze environmental data associated with the location, and establish a connection with at least one client system;
a memory storing instructions and data including multimodal input data, user preference data, behavioral models, and environmental configuration data;
a processor operatively coupled to the context awareness engine and the memory, the processor configured to execute instructions stored in the memory, the instructions when executed causing the processor to perform steps including:
receiving and processing multimodal input data from a plurality of sensors;
generating a virtual companion based at least in part on the processed multimodal input data and the detected location;
transitioning the virtual companion between a plurality of persona templates based on detected environmental context;
analyzing the multimodal input data using one or more trained machine learning models to determine an emotional state of the user;
selecting and generating one or more intervention strategies based on the determined emotional state and historical user response data;
dynamically adjusting one or more parameters of the virtual companion in response to changes in at least one of the user's location, the detected environmental context, or the determined emotional state; and
presenting the virtual companion to the user via at least one output device;
a communication interface configured to establish secure connections with the at least one client system using quantum key distribution (QKD) protocols and/or post-quantum cryptographic algorithms to secure data transmission during transitions between environments;
an edge computing module configured to: process time-sensitive data locally on a user device; reduce network bandwidth usage during environment transitions; and
maintain essential system functionality during temporary disconnections from the network; and
a backend platform comprising: a database configured to store and synchronize user data across a plurality of environments; and a server configured to process environmental data and update one or more behavioral models.

2. The system of claim 1, wherein the multimodal input data comprises: geolocation data; visual data captured by at least one camera; audio data captured by at least one microphone; motion data captured by at least one motion sensor; and biometric data captured by at least one biometric sensor.

3. The system of claim 1, wherein the context awareness engine is further configured to: detect entry into a geolocated environment using at least one of GPS signals, Bluetooth beacons, Wi-Fi triangulation, or optical markers; retrieve environment-specific data from the at least one client system; and organize user task data based on the retrieved environment-specific data.

4. The system of claim 3, wherein organizing user task data comprises: analyzing a user-provided list of items; mapping the items to respective locations within the geolocated environment; and determining an optimized navigation path through the environment based on item proximity.

5. The system of claim 1, wherein the memory stores a plurality of persona templates, and the processor instructions when executed further cause the processor to select a persona template based on the user's location and the detected environmental context; and to apply the selected persona template to the virtual companion.

6. The system of claim 5, wherein the persona templates include at least one of: a mascot persona associated with a retail environment; a specialized assistant persona associated with a task-specific domain; and an instructional persona configured to deliver step-by-step guidance.

7. The system of claim 1, wherein the processor instructions, when executed, further cause the processor to: analyze facial expressions based on visual data; analyze voice characteristics based on audio data; analyze physiological parameters based on biometric data; and determine the user's emotional state based on a fusion of the analyzed data.

8. The system of claim 7, wherein the processor analyzes the multimodal input data using one or more machine learning models trained to classify emotional states based on multimodal input features.

9. The system of claim 1, wherein the processor instructions, when executed, further cause the processor to: detect user frustration or stress; select an intervention strategy from a predefined strategy database; customize the selected strategy based on historical user response data; and deliver the customized strategy through the virtual companion.

10. The system of claim 9, wherein the intervention strategy comprises at least one of: adjusting task complexity; providing motivational feedback; suggesting sensory regulation techniques; or implementing guided breathing exercises.

11. The system of claim 1, wherein the communication interface employs the quantum key distribution (QKD) protocols and/or post-quantum cryptographic algorithms to: establish encrypted communication channels with the at least one client system; securely transmit user data between public and private environments; and protect sensitive user information during environmental transitions.

12. The system of claim 1, wherein the at least one output device comprises at least one of: a mobile device display; an augmented reality headset; a virtual reality headset; a smart speaker; or a wearable device with haptic feedback functionality.

13. The system of claim 1, wherein the backend platform is further configured to: collect anonymized user interaction data; aggregate the anonymized data across a plurality of users; analyze usage patterns to identify system improvement opportunities; and update the behavioral models based on the analyzed patterns.

14. The system of claim 1, wherein the processor instructions when executed further cause the processor to: detect completion of a task in a first environment; identify a related follow-up task in a second environment; transition the virtual companion to a persona appropriate for the second environment; and maintain task context during the transition between environments using quantum key distribution (QKD) protocols and/or post-quantum cryptographic algorithms to secure task data

15. The system of claim 14, wherein the first environment comprises a retail environment and the second environment comprises a private environment, and the related follow-up task comprises preparation instructions for one or more items obtained in the first environment.

16. (canceled)

17. The system of claim 1, wherein the processor instructions when executed further cause the processor to: adapt the representation of the virtual companion based on the capabilities of the output device; render the virtual companion using two-dimensional graphics on a mobile device; render the virtual companion using three-dimensional models in an augmented reality environment; and adjust rendering quality based on the processing capacity of the output device.

18. The system of claim 1, wherein the system is configured to operate in at least one of: a retail navigation mode configured to guide users through store environments; a task assistance mode configured to provide step-by-step instructions for task completion; an emotional support mode configured to deliver calming interventions; or a training mode configured to teach new skills through interactive guidance.

19. The system of claim 1, wherein the processor instructions, when executed, further cause the processor to: communicate with smart home devices; interface with point-of-sale systems in retail environments; connect with transportation information systems; and synchronize with one or more personal calendar or task management applications.

20. A method for providing context-aware adaptive virtual or augmented reality assistance, comprising:
detecting, by a context awareness engine, entry of a user into a geolocated environment;
establishing a secure connection with a client system associated with the geolocated environment using quantum key distribution (QKD) protocols and/or post-quantum cryptographic algorithms;
retrieving environment-specific data from the client system;
receiving multimodal input data from a plurality of sensors;
processing the multimodal input data using one or more trained machine learning models to determine user state information;
selecting a persona template based on the geolocated environment and detected environmental context;
generating a virtual companion using the selected persona template;
determining an emotional state of the user based on the multimodal input data;
adapting one or more responses of the virtual companion based on the determined emotional state;
providing task guidance through the virtual companion based on the environment-specific data;
detecting a transition to a second environment;
updating the virtual companion based on the second environment;
maintaining task context across the transition between environments; and
performing, by an edge computing module: processing time-sensitive data locally on a user device; reducing network bandwidth usage during environment transitions; and
maintaining essential system functionality during temporary disconnections from the network.
